(19) United States
(12) Patent Application Publication
(10) Pub. No.: US 2017/0114951 A1
(43) Pub. Date: Apr. 27, 2017

(54) DECOY MOUNTING STAKE FOR REMOTELY ROTATING A HUNTING DECOY

(71) Applicant: Cliff Lane, Slocomb, AL (US)

(72) Inventor: Cliff Lane, Slocomb, AL (US)

(21) Appl. No.: 14/921,939

(22) Filed: Oct. 23, 2015

(51) Int. Cl. F16M 13/02; A01M 31/06

(52) U.S. Cl. CPC F16M 13/022; A01M 31/06

(57) ABSTRACT

A decoy mounting stake is disclosed having remote string-controllable rotation. The mounting stake includes a rotatable vertical shaft having a top end configured to attach to a decoy and a bottom end configured to be inserted into the ground at a hunting location; a pair of first and second control arms, each attached to the rotatable vertical shaft and extending outward from the vertical shaft; and first and second control line mounting holes respectively placed at the ends of the first and second control arms at a distance from the shaft. Control lines can be attached to the mounting holes, and rotation and movement of a decoy attached to the decoy mounting stake can be controlled by a hunter in a remote blind via the control lines.

### FIELD OF THE INVENTION

This invention relates generally to hunting decoys, and more particularly to game bird hunting decoys.

### BACKGROUND OF THE INVENTION

Hunting has been a part of human survival since the dawn of man. While once purely a necessity, hunting has evolved with mankind, and has long been enjoyed as a sport and studied as a science, and is deeply rooted in our culture.

Wild turkeys are a prized prey in North America and elsewhere. Native to North America, the wild turkey is hunted both as a displayed trophy and for its meat. Depending on local rules and regulations, the wild turkey is hunted in the spring and fall. Spring hunting coincides with the wild turkey mating season, where gobblers can be called into shotgun range with calls that mimic the sounds of a hen. Fall seasons occur when turkeys are in flocks, and the typical fall hunt strategy is to scatter a flock of turkeys, and then use turkey calls to bring the game back. Decoys are particularly useful to lure wild turkeys to the hunter's location. Turkey hunters usually wear full camouflage, from head to toe, to conceal themselves from the wild turkey's excellent eyesight.

Due to the excellent eyesight of wild turkeys and other game, decoys that are used need to be realistic to attract the prey. Although realistic motion is a desirable feature to have in a decoy, it has been difficult to achieve.

### SUMMARY OF THE INVENTION

The present invention provides a decoy mounting stake that allows a hunter to remotely and discretely control via control lines the rotation of a decoy mounted thereon from a hunting blind so as to create realistic motion of the turkey decoy.

One general aspect of the invention is a decoy mounting stake having remote string-controllable rotation. The mounting stake includes: a vertical shaft having a top end configured to attach a turkey decoy, and a bottom end configured to insert into the ground at a hunting location; a pair of first and second control arms, each attached to the vertical shaft, and each extending outward from the vertical shaft terminating in a control line mounting point, the first and second control arms extending outward in different directions that span a separation angle.

In some embodiments, the separation angle is between 55 degrees and 70 degrees.

In some embodiments, the mounting stake further includes: an anti-snag protection member attached to the shaft, the anti-snag protection member having a curved surface also acts as a pulley or a roller so as to allow a greater turning radius.

In some embodiments, the mounting stake further includes: a tapered sleeve placed over the bottom end of the shaft, the tapered sleeve being sized so as to permit rotation of the bottom end of the shaft within the tapered sleeve.

In some embodiments, the top end of the shaft includes a threaded portion for attachment to a turkey decoy.

In some embodiments, the mounting stake further includes: a first spring attached to the top end of the shaft.

In some embodiments, the mounting stake further includes: a first spring attached to the top end of the shaft; and an extension shaft, the extension shaft being attached to the first spring such that the first spring is attached between the top end of the shaft and the extension shaft. In further embodiments, the extension shaft includes a top end with a threaded portion for attachment to a turkey decoy.

In some embodiments, the first and second control arms are each attached to the shaft at a plurality of mounting points.

Another general aspect of the invention is a method of mounting a turkey decoy, the method including: placing a decoy mounting stake in the ground at a hunting location, the shaft having a stationary bottom end inserted into the ground and a rotatable top end configured to support a turkey decoy, the shaft having a pair of control arms extending outward from the shaft at an angular relationship between the control arms; attaching control lines to each of the control arms; placing a decoy on the top end of the shaft; and pulling on the control lines to controllably rotate the shaft.

In some embodiments, tugging on the control lines simultaneously imparts a rocking motion to a turkey decoy. In further embodiments, the shaft includes a spring interface that is connectable to a turkey decoy. In further embodiments, motion is imparted to the decoy through the spring interface.

In some embodiments, attaching control lines includes attaching control lines from the control arms to the control arms on another instance of the decoy mount.

In some embodiments, placing the shaft in the ground includes placing a tapered sleeve over the bottom end of the shaft.

Another general aspect of the invention is a decoy mounting stake, including: a support shaft having a bottom end and a top end; a pair of control arms attached to the support shaft and extending outward from the support shaft, each control arm having a control line attachment point located at a distance from the shaft; and a decoy mounting interface located at the top end of the support shaft.

In some embodiments, the decoy mounting interface includes a spring portion.

In some embodiments, the decoy mounting interface includes a secondary shaft attached to the top of the spring portion.

In some embodiments, the decoy mount further includes a tapered sleeve placed over the bottom end of the shaft sized so as to permit rotation of the shaft within the tapered sleeve.

In some embodiments, the decoy mount further includes an anti-snag shield having a curved surface placed along the shaft between the top end and the bottom end that also acts as a pulley.

### BRIEF DESCRIPTION OF THE DRAWINGS

Many additional features and advantages of the present invention will become apparent upon reading the following detailed description, when considered in conjunction with the drawings.

FIG. 1 is a front view of a rotationally-controlled decoy mounting stake.

FIG. 1A is a side view of a turkey decoy mounted on the rotationally-controlled decoy mounting stake of FIG. 1.

FIG. 1B is a cut-away side view of the portion of FIG. 1A where the turkey decoy is attached to the decoy mounting stake.

FIG. 2 is a front view of an alternative embodiment of the mounting stake shown in FIG. 1, also having a spring joint.

FIG. 3 is a top view of a string arrangement for controlling the rotationally controlled mounted decoy of FIG. 1A. showing control lines attached to the mounting stake, and extending to a hunter's blind, from where a hunter controls rotation and/or movement of the decoy by pulling one or both of the control lines.

FIG. 4 is a top view of another string arrangement for controlling the rotationally controlled mounted decoy of FIG. 1A. showing control lines attached to the mounting stake, and extending to a hunter's blind, from where a hunter controls rotation of the mounting stake by pulling the control lines.

FIG. 5 is top view of the mounting stake of FIGS. 1 and 2 with an indication of a range of useful angle spans between the control arms attached to the mounting stake.

FIG. 6 is the top view of three decoy mounting stakes all controlled by a hunter in the BLIND using only two control lines, each mounting stakes supporting a turkey decoy being controlled from the hunter's blind.

FIG. 7 is a side view of a duck mounted on the rotationally-controlled mounting stake of FIG. 1.

### DETAILED DESCRIPTION

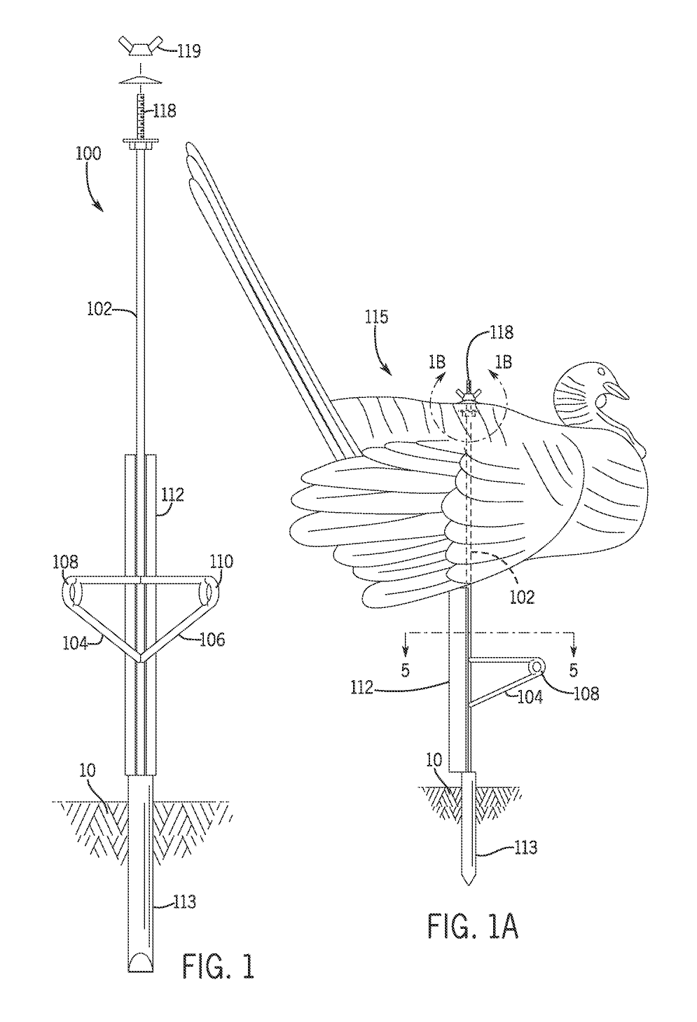

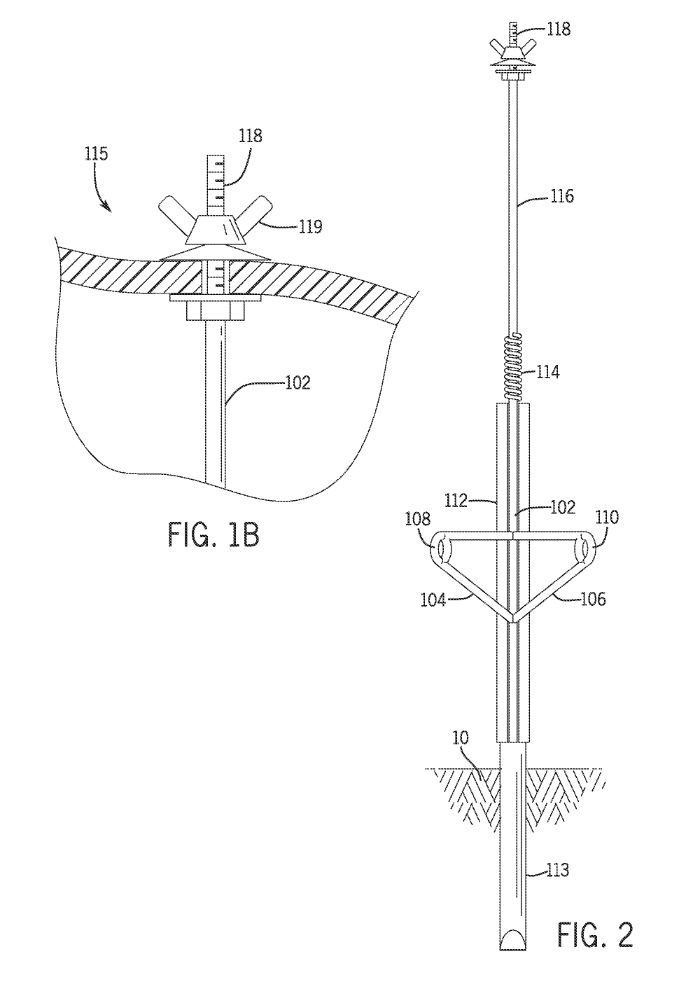

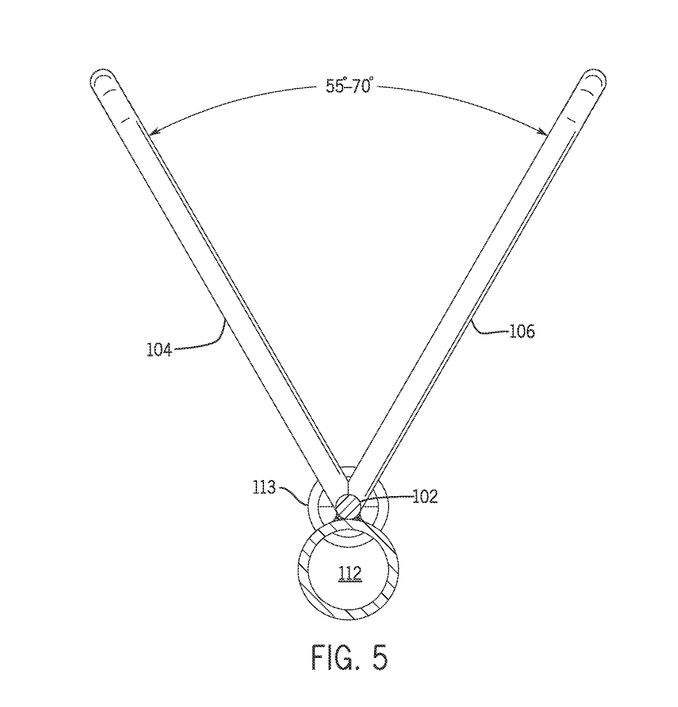

Referring to FIG. 1, a decoy mounting stake 100 has a vertical shaft 102 and control arms 104 and 106. Control arms 104 and 106 extend from the vertical shaft 102 at a separation angle of between 55 degrees and 70 degrees, for example (as shown in FIG. 5). In some embodiments, shaft 102 is made from ¼ inch metal rod, and has a length of at least 26 inches, for example (the length will vary depending on the type of decoy used). In some embodiments, control arms 104 and 106 are made from metal rods having diameters of approximately 3/16 inch to ¼ inch.

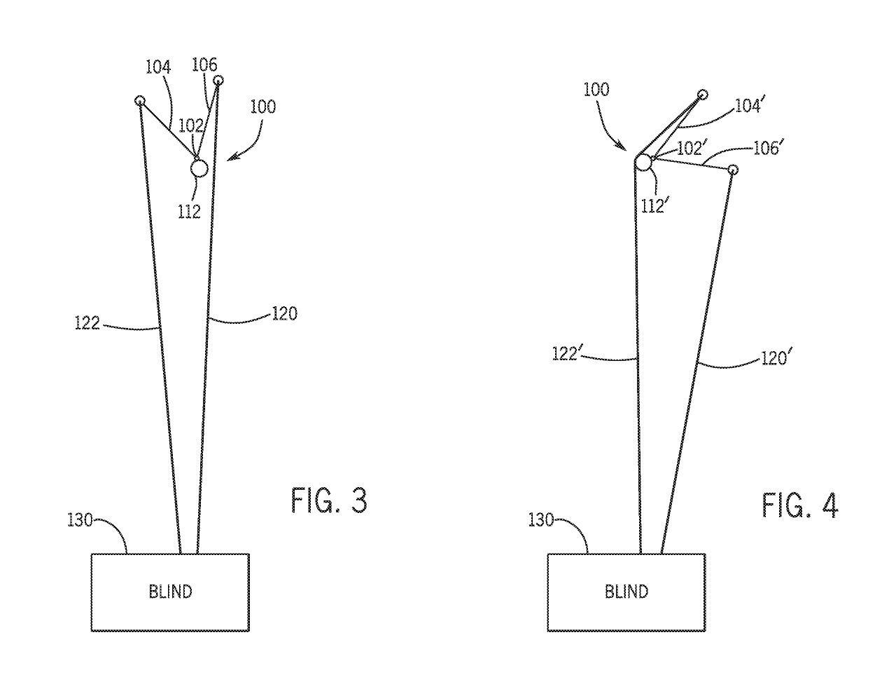

Control arms 104 and 106 extend from shaft 102 to present control line mounting holes 108 and 110. Control lines are attached to and run from mounting holes 108 and 110 to a hunting blind that allows a hunter to unobtrusively rotate shaft 102 when a decoy is placed on decoy mounting stake 100 (as shown in FIG. 3, for example).

In some embodiments, shaft 102 and control arms 104 and 106 are made from cold roll metal rods, which is readily available from building supply sources and is highly durable. However, the surface of rebar is typically rough, and easily snags control lines that are made of plastic, such as found in fishing line. To avoid this problem, elongated, anti-snag member 112, having a smooth curved surface, can be included along the length of shaft 102, and can be secured with fasteners, such as zip ties, tape, or it can be welded to shaft 102. In some embodiments, anti-snag member 112 is a tube having a diameter of at least approximately one inch.

In some embodiments, tapered ground sleeve 113, having a diameter larger than the diameter of shaft 102, can be inserted into the ground 10. Tapered ground sleeve 113 has an inner diameter sufficiently dimensioned to allow the bottom end of shaft 102 to freely rotate. In some embodiments, tapered ground sleeve 113 is a metal or plastic tube having an interior diameter of at least ⅜ inch, and incorporates a tapered or sharp end that is pushed or pounded into the ground to receive the shaft 102 of decoy mounting stake 100. In some embodiments, where ground 10 is soft enough, tapered ground sleeve 113 is not necessary, and shaft 102 can be pressed directly into ground 10 and worked back and forth so as to create clearance for shaft 102 to rotate within freely.

Referring to FIG. 1A, a turkey decoy 115 is shown mounted on the decoy mounting stake 100 using shaft 102 and the threaded post 118, which extends upward through a hole in the turkey decoy 115. The wing nut 119 is tightened down along the threaded post 118 so as to secure the turkey decoy 115 on the decoy mounting stake 100.

Referring to FIG. 1B, a close up view is presented showing how the wing nut 119 is tightened down along the threaded post 118 so as to secure the turkey decoy 115 on the shaft 102 of the decoy mounting stake 100.

Referring to FIG. 2, in some embodiments, shaft 102 incorporates a spring 114 and an extension member 116. In this embodiment, extension member 116 supports a turkey decoy, and works with the spring 114 to enable a decoy to wobble or shake atop decoy mounting stake 100 so as to attract game to the hunting site. As is shown in FIG. 2, the top of extension member 116 can incorporate a threaded post 118 that can be used to secure a decoy to decoy mounting stake 100.

Referring to FIG. 3, a decoy 115 is placed on top of decoy mounting stake 100. A realistic turkey decoy, which can include moving parts to simulate live game, is placed on decoy mounting stake 100 so that the decoy 115 is elevated at a distance above the ground 10 at which a typical game would stand. When decoy mounting stake 100 is made to rotate by a hunter hiding in a blind 130 and pulling on one of the control lines 120 and 122 attached to control arms 106 and 104, respectively, the orientation of the decoy 115 atop the decoy mounting stake 100 changes.

Control line 120 is controlled by the hunter and extends outward from the blind 130 and is attached to control arm 106, and control line 122 is attached to control arm 104. The hunter can remotely operate decoy mount 100, by selectively pulling on control lines 120 and 122, thereby causing decoy mount 102 to rotate, or to simply introduce motion to an attached decoy by tugging on control lines 120 and 122 when decoy mount 102 includes spring 114 and extension member 116, as shown in FIG. 2.

Referring to FIG. 4, the decoy 115 on the mounting stake 100 has been turned clockwise by pulling on the line 120′, which pulls on the arm 106′, which rotates the shaft 102. The line 122′ bends around the anti-snag member 112, which prevents the line 122′ from catching on the shaft 102. Pulling on control lines 120′ and 122′ causes decoy mount 102 to rotate, thereby bringing anti-snag member 112′ into contact with control line 120′. When this occurs, control line 120′ easily separates from contact with the smooth surface of anti-snag member 112′, which acts like a roller.

FIG. 5 shows a top view of shaft 102 and anti-snag member 112, indicating a range of useful angles at which control arms 104 and 106 can be positioned on shaft 102 with respect to each other. In some embodiments, control arms 104 and 106 can be arranged at any angle from about 55 degrees to about 70 degrees from each other.

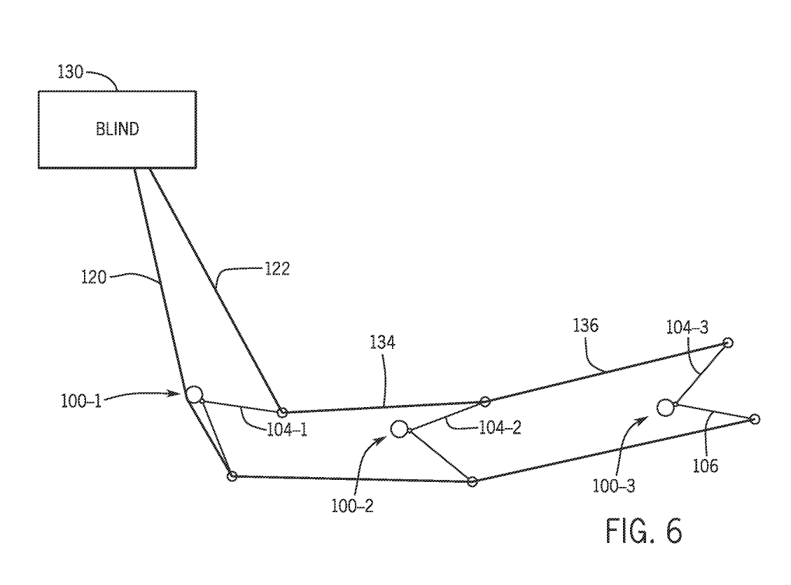

As shown in FIG. 6, multiple decoy mounts 100-1, 100-2, 10-3 can be controlled from a single pair of control lines, thereby controlling multiple decoys using the single pair of control lines. Decoy mount 100-1 can be rotated counter clockwise by pulling on control line 122, which is in turn connected to both control line 134 and control arm 104-1. Movement of control arm 104-1 pulls on the control line 134, which pulls on the control arm 104-2, thereby causing counter clockwise rotation of the decoy mount 100-2. Such counter clockwise rotation of decoy mount 100-2 causes control arm 104-2 to pull on control line 136. Since control line 136 is attached to control arm 104-3, pulling on control line 136 causes counter clockwise rotation of the decoy mount 100-3. Thus, pulling on control line 122 causes all three decoy mounts 100-1, 100-2, 100-3 to rotate, thereby rotating each corresponding decoy supported thereby. While three instances of decoy mounts are shown connected and operated in this manner, many different configurations can be realized with other numbers of decoy mounts 100, such as two, four, five, six, etc.

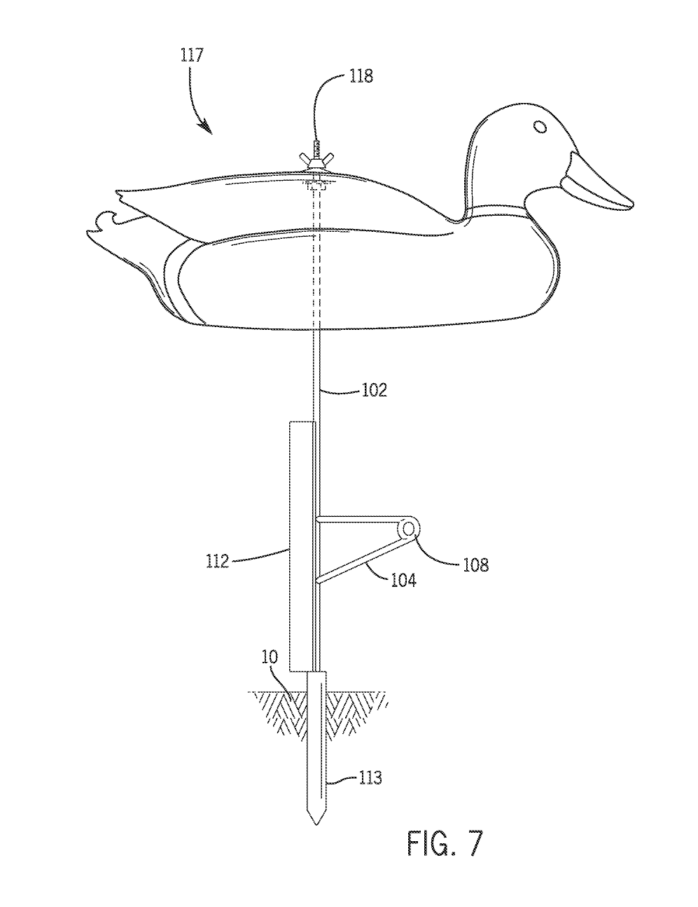

Referring to FIG. 7, instead of a turkey decoy, a decoy representing another type of game bird can be used, such as a duck decoy 117, which is mounted upon the decoy mount 100 just as shown and explained in FIG. 1.

While a decoy mount apparatus and method have been described and illustrated in detail, it is to be understood that numerous modifications and changes can be made to embodiments of the present invention without departing from the spirit and the scope of the invention as set forth in the following claims.

What is claimed is:

1. A decoy mounting stake having remote string-controllable rotation, the decoy mounting stake comprising:
a vertical shaft having a top end configured to attach a turkey decoy, and a bottom end configured to insert into the ground at a hunting location;
a pair of first and second control arms, each attached to the vertical shaft, and each extending outward from the vertical shaft terminating in a control line mounting point, the first and second control arms extending outward in different directions that span a separation angle, each control arm being configured to be pulled by a control line.

2. The decoy mounting stake of claim 1, wherein:
the separation angle is an angle between 55 degrees and 70 degrees.

3. The decoy mounting stake of claim 1, further including:
an anti-snag protection member attached to the shaft, the anti-snag protection member having a curved surface that acts like a roller.

4. The decoy mounting stake of claim 1, further including:
a tapered sleeve placed over the bottom end of the shaft, the tapered sleeve sized so as to permit rotation of the bottom end of the shaft within the tapered sleeve.

5. The decoy mounting stake of claim 1, wherein:
the top end of the shaft includes a threaded portion for attachment to a turkey decoy.

6. The decoy mounting stake of claim 1, further including:
a first spring attached to the top end of the shaft.

7. The decoy mounting stake of claim 1, further including:
a first spring attached to the top end of the shaft; and
an extension shaft, the extension shaft being attached to the first spring such that the first spring is attached between the top end of the shaft and the extension shaft.

8. The decoy mounting stake of claim 7, wherein:
the extension shaft includes a top end with a threaded portion for attachment to a turkey decoy.

9. The decoy mounting stake of claim 1, wherein:
the first and second control arms are each attached to the shaft at a mounting point along the shaft.

10. A method of mounting a turkey decoy, comprising:
placing a decoy mounting stake in the ground at a hunting location, the shaft having a stationary bottom end inserted into the ground and a rotatable top end configured to support a turkey decoy, the shaft having a pair of control arms extending outward from the shaft at an angular relationship between the control arms;
attaching control lines to each of the control arms;
placing a decoy on the top end of the shaft; and
pulling on the control lines to controllably rotate the shaft.

11. The method of claim 10, wherein:
tugging on the control lines simultaneously imparts a rocking motion to a turkey decoy.

12. The method of claim 11, wherein shaft includes a spring interface that is connectable to a turkey decoy.

13. The method of claim 12, wherein:
motion is imparted to the decoy through the spring interface.

14. The method of claim 10, wherein:
attaching control lines includes attaching control lines from the pair of control arms to another pair of control arms on another instance of the decoy mount.

15. The method of claim 10, wherein:
placing the shaft in the ground includes placing a tapered sleeve over the bottom end of the shaft.

16. A decoy mounting stake comprising:
a support shaft having a bottom end and a top end;
a pair of control arms attached to the support shaft and extending outward from the support shaft, each control arm having a control line attachment point located at a distance from the shaft; and
a decoy mounting interface located at the top end of the support shaft.

17. The decoy mount of claim 16, wherein:
the decoy mounting interface includes a spring portion.

18. The decoy mount of claim 17, wherein:
the decoy mounting interface includes a secondary shaft attached to the top of the spring portion.

19. The decoy mount of claim 16, further including:
a tapered sleeve placed over the bottom end of the shaft sized so as to permit rotation of the shaft within the tapered sleeve.

20. The decoy mount of claim 16, further including:
an anti-snag shield having a curved surface placed along the shaft between the top end and the bottom end, the anti-snag shield also acting like a roller.
